(19) United States
(12) Patent Application Publication
(10) Pub. No.: US 2024/0039230 A1
(43) Pub. Date: Feb. 1, 2024

(54) DEVICE FOR CONVERTING FREQUENCY OF ELECTROMAGNETIC WAVE

(71) Applicants: Korea Advanced Institute of Science And Technology, Daejeon (KR); Center for Advanced Meta-Materials, Daejeon (KR)

(72) Inventors: Bumki MIN, Daejeon (KR); Kang Hee LEE, Daejeon (KR); Seojoo LEE, Daejeon (KR); Soojeong BAEK, Daejeon (KR)

(73) Assignees: Korea Advanced Institute of Science And Technology, Daejeon (KR); Center for Advanced Meta-Materials, Daejeon (KR)

(21) Appl. No.: 18/266,202

(22) PCT Filed: Dec. 7, 2021
(86) PCT No.: PCT/KR2021/018453

§ 371 Date: Jun. 8, 2023

(30) Foreign Application Priority Data
Dec. 10, 2020 (KR) 10-2020-0172459

(51) Int. Cl. H01S 3/08; G02F 1/35; G02F 1/355

(52) U.S. Cl. CPC H01S 3/08086; G02F 1/353; G02F 1/3556

(57) ABSTRACT

The present invention relates to a device for converting a frequency of an electromagnetic wave and, more specifically, to a device for converting an original frequency of an electromagnetic wave into a frequency corresponding to a resonator mode by using a time-varying Fabry-Perot resonator including a time-varying reflective surface of which reflectivity changes with time. A device for converting a frequency of an electromagnetic wave according to an embodiment of the present invention comprises: a time-varying reflective surface on which an electromagnetic wave is incident and of which reflectivity changes with time; and a partially reflective surface which is disposed at a predetermined distance from the time-varying reflective surface, from which an electromagnetic wave having a frequency corresponding to a resonator mode is emitted, and which has a fixed reflectivity for partially reflecting the electromagnetic wave incident through the time-varying reflective surface, wherein the reflectivity of the time-varying reflective surface is smaller than the reflectivity of the partially reflective surface, and after the electromagnetic wave is trapped between the time-varying reflective surface and the partially reflective surface, the reflectivity of the time-varying reflective surface becomes greater than the reflectivity of the partial reflective surface.

### CROSS REFERENCE

This application claims priority to and the benefit of PCT Application Number PCT/KR2021/018453 on Dec. 7, 2021 and South Korean Patent Application No 10-2020-0172459 filed in the Korean Intellectual Property Office on Dec. 10, 2020, the entire contents of which are incorporated herein by reference.

### TECHNICAL FIELD

The present invention relates to a device for converting a frequency of an electromagnetic wave and, more specifically, to a device for converting an original frequency of an electromagnetic wave into a frequency corresponding to a resonator mode by using a time-varying Fabry-Perot resonator including a time-varying reflective surface of which reflectivity changes as time elapses.

### BACKGROUND ART

A frequency is one of the important fundamental properties of electromagnetic waves such as light and microwaves.

Technologies using nonlinear materials or elements are used as common methods for adjusting a frequency of an electromagnetic wave. However, these technologies are limited in their use when the intensity of the electromagnetic wave is weak. Therefore, there is a need for a technology for converting a frequency of an electromagnetic wave, which provides sufficiently high conversion efficiency even when the intensity of the incident electromagnetic wave is weak.

Thus, to adjust the frequency of the electromagnetic wave, a method using a time-varying material or element, instead of a method using a nonlinear material or element has recently been reported.

### DISCLOSURE OF THE INVENTION

### Technical Problem

An object of the prevent invention for solving the above problem is to provide a device and method for converting a frequency of an electromagnetic wave, which exhibits sufficiently high conversion efficiency even when an intensity of the incident electromagnetic wave is weak.

In addition, an object of the prevent invention for solving the above problem is to provide a device and method for converting a frequency of an electromagnetic wave, which exhibits high conversion efficiency by utilizing a time-varying Fabry-Perot resonator device.

### Technical Solution

A device for converting a frequency of an electromagnetic wave according to an embodiment of the present invention includes: a time-varying reflective surface onto an electromagnetic wave is incident and of which reflectivity changes as time elapses, and a partial reflective surface which is disposed to be spaced a predetermined distance from the time-varying reflective surface, from which an electromagnetic wave having a frequency corresponding to a resonator mode is emitted, and which has fixed reflectivity for partially reflecting the electromagnetic wave incident through the time-varying reflective surface, wherein the reflectivity of the time-varying reflective surface is less than the reflectivity of the partial reflective surface, and after the electromagnetic wave is trapped between the time-varying reflective surface and the partial reflective surface, the reflectivity of the time-varying reflective surface increases to be greater than the reflectivity of the partial reflective surface.

A device for converting a frequency of an electromagnetic wave according to another embodiment of the present invention includes: a semiconductor wafer including a time-varying reflective surface onto which an electromagnetic wave is incident and of which reflectivity changes as time elapses; and a reflective film including a partial reflective surface which is disposed to be spaced a predetermined distance from the semiconductor wafer, from which an electromagnetic wave having a frequency corresponding to a resonator mode is emitted, and which has fixed reflectivity for partially reflecting the electromagnetic wave incident through the semiconductor wafer, wherein the reflectivity of the time-varying reflective surface is less than the reflectivity of the partial reflective surface and increases by an ultrafast laser pulse incident through the reflective film so as to be greater than the reflectivity of the partial reflective surface.

A device for converting a frequency of an electromagnetic wave according to further another embodiment of the present invention includes: a semiconductor wafer configured to receive an electromagnetic wave and an ultrafast laser pulse to emit a resonance mode electromagnetic wave having a frequency corresponding to a resonator mode, wherein one surface of both surfaces of the semiconductor wafer is a time-varying reflective surface onto which the electromagnetic wave is incident and of which reflectivity changes as time elapses, a reflective pattern having fixed reflectivity for partially reflecting the electromagnetic wave is disposed on the other surface of both surfaces of the semiconductor wafer, and the reflectivity of the time-varying reflective surface is less than the reflectivity of the reflective pattern and increases by an ultrafast laser pulse so as to be greater than the reflectivity of the reflective pattern.

### Advantageous Effects

According to an embodiment of the present invention, the device and method for converting the electromagnetic wave frequency having the high frequency conversion efficiency may be provided.

In addition, according to an embodiment of the present invention, the resonator may be adjusted in length by the time-varying Fabry-Pero resonator to provide electromagnetic wave frequency conversion technique capable of adjusting the conversion frequency.

In addition, according to an embodiment of the present invention, the specific method for manufacturing the time-varying Fabry-Pero resonator device using the optically pumped semiconductor wafer may be provided.

### BRIEF DESCRIPTION OF THE DRAWINGS

FIG. 1 is a view for explaining an operation principle of a device 100 for converting an electromagnetic wave frequency according to an embodiment of the present invention.

FIG. 1 is a view for explaining an operation principle of a device 200 for converting an electromagnetic wave frequency according to another embodiment of the present invention.

FIG. 3 is a front view illustrating an example of a reflective film 200 of FIG. 2.

FIG. 4 is a frequency conversion spectrum 400 obtained by allowing a predetermined electromagnetic wave to be incident into the device 200 for converting the electromagnetic wave frequency, which is illustrated in FIG. 2, so as to actually convert the electromagnetic wave frequency.

FIG. 5 is a view for explaining an operation principle of a device 500 for converting an electromagnetic wave frequency according to further another embodiment of the present invention.

### MODE FOR CARRYING OUT THE INVENTION

Hereinafter, various embodiments of this document will be described with reference to the accompanying drawings. However, this does not limit this document within specific embodiments, but it should be understood that the present disclosure covers all modifications, equivalents, and alternatives according to embodiments of the present disclosure. In the description with reference to the drawings, like reference numerals may be used for referring to the same or similar components.

Also, since the size and thickness of each of the components illustrated in the drawings are arbitrarily shown for convenience of description, the present invention is not necessarily limited to the illustrated. In the drawings, thicknesses of the components are enlarged to clearly express various layers and areas. Also, in the drawings, the thicknesses of layers and regions are enlarged for convenience of description.

Terms used in this document are only used to describe a specific embodiment and may not be intended to limit the scope of other embodiments. The terms of a singular form may include plural forms unless referred to the contrary. All terms used herein, which include technical or scientific terms, may have the same meaning as commonly understood by one of ordinary skill in the art of the present invention. Terms defined in general used in the dictionary may be interpreted as having the same or similar meaning as the meaning in the context of the related art, and unless explicitly defined in this document, it is not interpreted in an ideal or excessively formal meaning. In some cases, even terms defined in this document may not be construed to exclude embodiments of the present invention.

Preferred embodiments of the present invention will be described below in more detail with reference to the accompanying drawings.

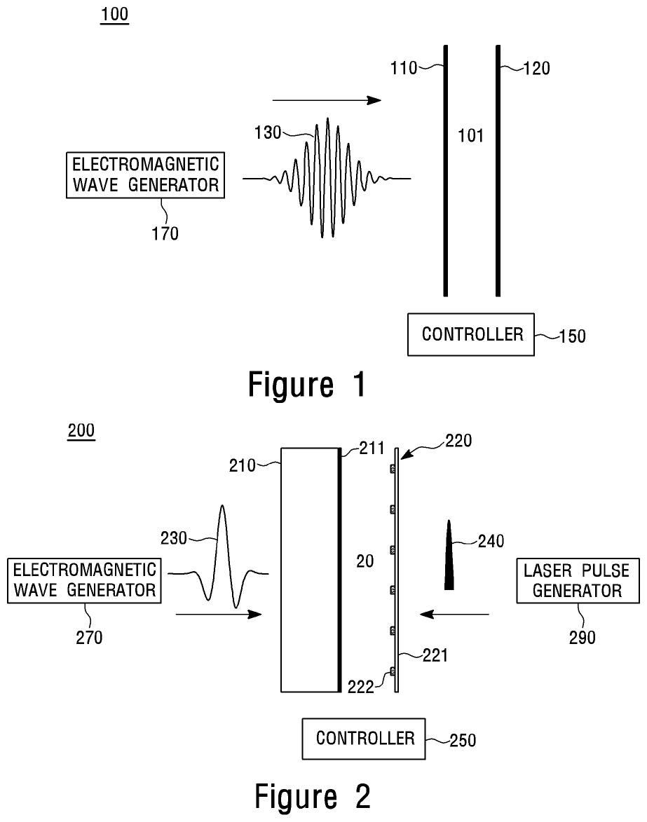

FIG. 1 is a view for explaining an operation principle of a device 100 for converting an electromagnetic wave frequency according to an embodiment of the present invention.

In FIG. 1, for explaining an operation principle of the device 100 for converting the electromagnetic wave frequency according to an embodiment of the present invention, a conceptual time-varying Fabry-Perot resonator is used.

The device 100 for converting the electromagnetic wave frequency according to an embodiment of the present invention includes a time-varying reflective surface 110 and a partial reflective surface 120.

The time-varying reflective surface 110 is a surface into which the electromagnetic wave 130 is incident, and reflectivity thereof changes as time elapses. The time-varying reflective surface 110 has a relatively low reflectivity when the electromagnetic wave 130 in the form of a pulse is introduced into a space 101 between the time-varying reflective surface 110 and the partial reflective surface 120 and then has a reflectivity that relatively increases after the electromagnetic wave 130 is introduced into the space 101. Thus, the electromagnetic wave 130 incident through the time-varying reflective surface 110 is trapped inside the space 101.

The reflectivity of the time-varying reflective surface 110 is less than that of the partial reflective surface 120, and after the electromagnetic wave 130 is trapped between the time-varying reflective surface 110 and the partial reflective surface 120, the reflectivity of the partial reflective surface 120 is greater than that of the partial reflective surface 120.

The partial reflective surface 120 is a surface from which the electromagnetic wave having a frequency corresponding to a resonator mode are emitted and has a fixed partial reflectivity in which the reflectivity does not change as time elapses.

The reflectivity of the partial reflective surface 120 has a reflectivity greater than that before the reflectivity of the time-varying reflective surface 110 increases and has a reflectivity less than that after the reflectivity of the time-varying reflective surface 110 increases.

The electromagnetic wave trapped inside the space 101 between the time-varying reflective surface 110 and the partial reflective surface 120 is escaped to the outside through the partial reflective surface 120. The electromagnetic wave escaped from the space 101 through this process may have only a frequency corresponding to the resonator mode (resonance mode frequency). Therefore, the frequency is changed from the incident electromagnetic wave frequency to the resonance mode frequency.

The device 100 for converting the electromagnetic wave frequency according to an embodiment of the present invention may directly select the converted electromagnetic wave frequency by adjusting an interval between the time-varying reflective surface 110 and the partial reflective surface 120.

The device 100 for converting the electromagnetic wave frequency according to an embodiment of the present invention may further include a controller 150.

The controller 150 may control the reflectivity of the time-varying reflective surface 110. For example, the controller 150 may control the reflectivity of the time-varying reflective surface 110 to be less than a fixed reflectivity of the partial reflective surface 120 or to be greater than the fixed reflectivity of the partial reflective surface 120.

In addition, the controller 150 may adjust a length between the time-varying reflective surface 110 and the partial reflective surface 120. The frequency of the electromagnetic wave emitted through the partial reflective surface 120 may be set and changed through the controller 150. Here, the controller 150 for adjusting the length between the time-varying reflective surface 110 and the partial reflective surface 120 may be configured separately from a controller 150 for controlling the reflectivity of the time-varying reflective surface 110 described above.

The device 100 for converting the electromagnetic wave frequency according to an embodiment of the present invention may further include an electromagnetic wave generator 170 emitting the electromagnetic wave 130. The electromagnetic wave generator 170 may generate the electromagnetic wave 130 under the control of the controller 150.

FIG. 1 is a view for explaining an operation principle of a device 200 for converting an electromagnetic wave frequency according to another embodiment of the present invention.

In the device 200 for converting the electromagnetic wave frequency, which is illustrated in FIG. 2, according to another embodiment of the present invention, one surface of a semiconductor wafer 210, which is optically pumped by an ultrafast laser pulse 240 is defined as the time-varying reflective surface 211, and a space 201 between the semiconductor wafer 210 and a reflective film 220 is defined as the inside of a Fabry-Perot resonator.

In the embodiment illustrated in FIG. 2, the time-varying reflective surface 211 may be one surface of both surfaces of the semiconductor wafer 210, and more specifically, the time-varying reflective surface 211 may be one surface that is optically pumped by the ultrafast laser pulse 240. Alternatively, the time-varying reflective surface 211 may be one surface of both the surfaces of the semiconductor wafer 210, which is disposed closer to the reflective film 220.

The reflective film 220 has a partial reflective surface of a time varying Fabry-Perot resonator. The reflective film 220 includes a film 221 having good transmittance to the ultrafast laser pulse 240 and the electromagnetic wave 230 and a reflective pattern 222 having a partial reflectivity of only the electromagnetic wave 230 on one side of the film 221.

After the electromagnetic wave 230 is incident into the semiconductor wafer 200 from one side of the semiconductor wafer 200, when the incident electromagnetic wave 230 is introduced between the time-varying reflective surface 211 and the reflective film 220, the ultrafast laser pulse 240 incident from the other side of the semiconductor wafer 200 passes through the reflective film 220 and is incident into the time-varying reflective surface 211 of the semiconductor wafer 210. The ultrafast laser pulse 240 incident into the time-varying reflective surface 211 allows the reflectivity of the time-varying reflective surface 211 to increase through light pumping. The electromagnetic wave 230 incident due to the increasing reflectivity with respect to time is trapped between the semiconductor wafer 200 and the reflective film 220 in this manner.

Since the semiconductor wafer 210 has to serve to increase in reflectivity by light pumping, it is preferably made of silicon or gallium arsenide (GaAs) that is light-pumped by the ultrafast laser pulse 240.

The film 221 may be made of silicon nitride (SiN), polydimethylsiloxane (PDMS), polyimide (PI), or the like, through which light and radio waves are easily transmitted. Here, as long as the reflective pattern 222 is capable of being maintained even without the film 221, the film 221 may not be present.

A thickness of the film 221 may be greater than or equal to a minimum thickness at which the film is capable of being maintained, but if the thickness is too thick, an additional Fabry-Perot effect will be resulted. Therefore, it is preferable that a wavelength is less than the wavelength of the incident electromagnetic wave 230.

The device for converting the electromagnetic wave frequency, which is illustrated in FIG. 2, may further includes a controller 250 that controls the emission of the electromagnetic wave 230 to the semiconductor wafer 210 and the emission of the ultrafast laser pulse 240 to the reflective film 220.

In addition, the device for converting the electromagnetic wave frequency, which is illustrated in FIG. 2, may further include an electromagnetic wave generator 270 emitting the electromagnetic wave 230 and a laser pulse generator 290 generating the ultrafast laser pulse 240. The electromagnetic wave generator 170 and the laser pulse generator 290 may generate the electromagnetic wave 130 and the ultrafast laser pulse 240 under the control of the controller 150.

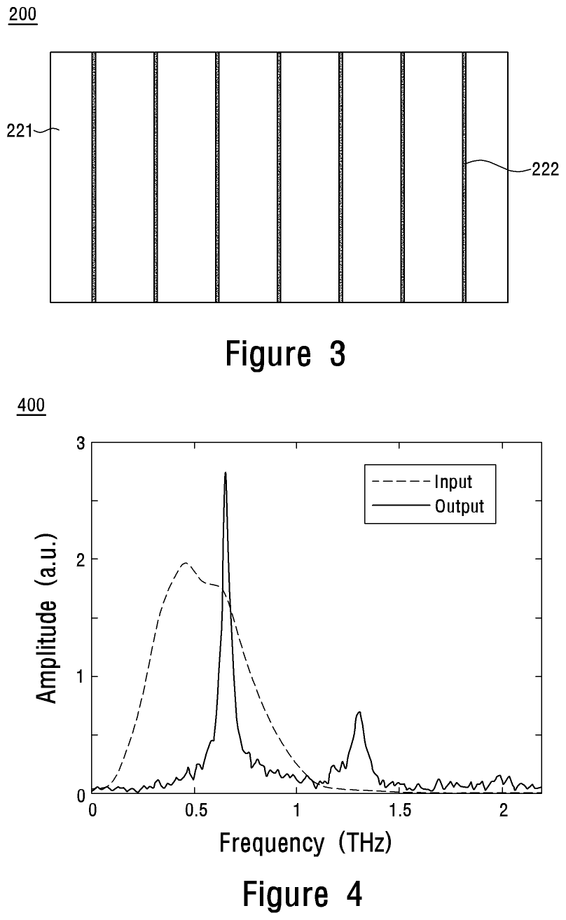

FIG. 3 is a front view illustrating an example of the reflective film 200 of FIG. 2.

Referring to FIG. 3, the reflective film 200 includes a film 221 and a reflective pattern 222 patterned in the form of a wire grid on the film 221.

It is preferable that an area occupied by the reflective pattern 222 patterned in the form of the wire grid is small compared to the entire surface of one surface of the film 221. This is because the ultra-fast laser pulse 240 that causes a time change of the time-varying reflective surface 211 illustrated in FIG. 2 has to sufficiently pass.

The reflective pattern 222 has to reflect the incident electromagnetic wave 230 to some extent, and for this purpose, the reflective pattern 222 preferably has the wire grid shape. Here, a direction of the wires is parallel to an electric field direction of the incident electromagnetic wave 230.

Due to the reflective pattern 222 having the wire grid shape, there may be a portion of the semiconductor wafer 200 at which the ultrafast laser pulse 240 does not reach, but if a width of the reflective pattern 222 is much less than a distance defining the inside of the resonator, i.e., a distance between the time-varying reflective surface 211 of the wafer 200 and the reflective film 220, it may be ignored due to diffraction.

If a period of the reflective pattern 222 having the wire grip shape is significantly less than that of the wavelength of the incident electromagnetic wave 230, it may have sufficient reflectivity. Therefore, it is preferable that the period of the reflective pattern 222 having the wire grid shape is significantly less than that of the wavelength of the incident electromagnetic wave 230.

The reflective pattern 222 may be replaced with a surface capable of partially reflecting the incident electromagnetic wave 230 while the ultrafast laser pulse 240 well passes therethrough, in addition to the wire grid shape. For example, indium tin oxide ITO or the like may be utilized.

FIG. 4 is a frequency conversion spectrum 400 obtained by allowing a predetermined electromagnetic wave to be incident into the device 200 for converting the electromagnetic wave frequency, which is illustrated in FIG. 2, so as to actually convert the electromagnetic wave frequency.

The frequency conversion spectrum 400 illustrated in FIG. 4 shows measured results. Here, the incident electromagnetic wave 230 in FIG. 2 used a terahertz wave with a single period, the semiconductor wafer 210 used gallium arsenide, the film 221 having good transmittance of the ultrafast laser pulse 240 and the electromagnetic wave 230 used the polyimide (PI) film. The reflective pattern having the wire grid shape as shown in FIG. 3 was used for the reflective pattern 222.

As illustrated in FIG. 4, it is seen that, when a broadband incident frequency of the single-period electromagnetic wave 230 is coupled to the time-varying Fabry-Perot resonator illustrated in FIG. 2 at an appropriate timing, the frequency is converted to a frequency corresponding to the resonator mode.

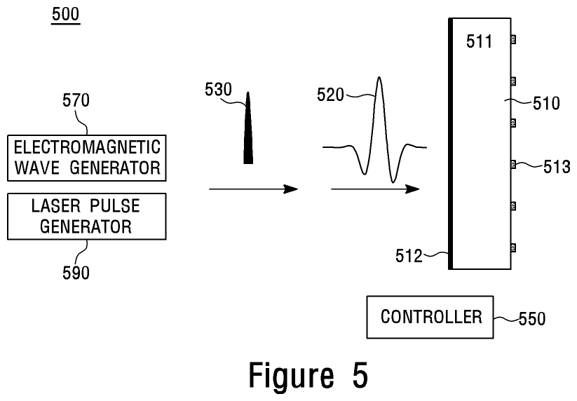

FIG. 5 is a view for explaining an operation principle of a device 500 for converting an electromagnetic wave frequency according to further another embodiment of the present invention.

Unlike the device for converting the electromagnetic wave frequency illustrated in FIG. 2, a device 500 for converting an electromagnetic wave frequency illustrated in FIG. 5 provide an embodiment of a time-varying Fabry-Perot resonator in which the inside 511 of a semiconductor wafer 510 serves as a resonator.

Referring to FIG. 5, the device 500 for converting the electromagnetic wave frequency according to another embodiment of the present invention includes a semiconductor wafer 510.

The semiconductor wafer 510 has both surface. One of both the surfaces is a time-varying reflective surface 512, and the other surface is a surface on which the reflective pattern 513 is disposed.

An electromagnetic wave 520 and an ultrafast laser pulse 530 are incident into the semiconductor wafer 510. Specifically, the electromagnetic wave 520 and the ultrafast laser pulse 530 are incident into the time-varying reflective surface 512 of the semiconductor wafer 510.

In the embodiment of FIG. 5, the time-varying reflective surface 512 is one surface of the light-pumped semiconductor wafer 510 as in FIG. 2. As illustrated in FIG. 5, the light pumping that causes such a time change is performed by the ultrafast laser pulse 530 incident in the same direction as the incident electromagnetic wave 520.

In the embodiment of FIG. 5, a partial reflective surface may be a reflective pattern 513 having a partial reflectivity with respect to the incident electromagnetic wave 520. Unlike FIG. 2, the ultrafast laser pulse 530 does not pass through the reflective pattern 513 functioning as such a partial reflective surface, and thus transmission of the ultrafast laser pulse 530 does not need to be considered. Therefore, when the partial reflective surface is applied as the metal pattern 513, various shapes in addition to the wire grid shape of FIG. 2 may be applied.

The reflective pattern 513 having partial reflectivity for the incident electromagnetic wave 520 has the same function if it is not a reflective pattern but a surface that partially reflects the incident electromagnetic wave 520. Therefore, instead of the reflective pattern 513, another material may be substituted, and a very thin metal surface or ITO applied on the other surface of the semiconductor wafer 510 may be substituted.

When the semiconductor wafer 510 having both surfaces that are a reflective pattern and a time-varying reflective surface, respectively, in FIG. 5 is used as a time-varying Fabry-Perot resonator, the converted electromagnetic wave frequency is determined by a thickness of the semiconductor wafer 510.

The device for converting the electromagnetic wave frequency, which is illustrated in FIG. 5, may further includes a controller 550 that controls the emission of the electromagnetic wave 520 and the ultrafast laser pulse 530 to the reflective film 220.

The device according to the embodiment of the present invention may be utilized for time-varying properties of the semiconductor wafer to which optical pumping is applied, but may be replaced with other types of switching elements such as electrically operating modulators. However, there may be a limit in the operating frequency band due to an operating speed limit of the switching element.

In addition, the device 500 for converting the electromagnetic wave frequency, which is illustrated in FIG. 5, may further include an electromagnetic wave generator 570 emitting the electromagnetic wave 530 and a laser pulse generator 590 generating the ultrafast laser pulse 520. The electromagnetic wave generator 570 and the laser pulse generator 590 may generate the electromagnetic wave 530 and the ultrafast laser pulse 520 under the control of the controller 550.

The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art.

Therefore, the scope of the invention is defined not by the detailed description of the invention but by the appended claims, and all differences within the scope will be construed as being included in the present invention.

### DESCRIPTION OF THE SYMBOLS

100: Device for converting frequency of electromagnetic wave
110: Time-varying reflective surface
120: Partial reflective surface
150: Controller
170: Electromagnetic wave generator

1. A device for converting a frequency of an electromagnetic wave, the device comprising:
a time-varying reflective surface onto an electromagnetic wave is incident and of which reflectivity changes as time elapses; and
a partial reflective surface which is disposed to be spaced a predetermined distance from the time-varying reflective surface, from which an electromagnetic wave having a frequency corresponding to a resonator mode is emitted, and which has fixed reflectivity for partially reflecting the electromagnetic wave incident through the time-varying reflective surface,
wherein the reflectivity of the time-varying reflective surface is less than the reflectivity of the partial reflective surface, and after the electromagnetic wave is trapped between the time-varying reflective surface and the partial reflective surface, the reflectivity of the time-varying reflective surface increases to be greater than the reflectivity of the partial reflective surface.

2. The device of claim 1, further comprising:
an electromagnetic wave generator configured to generate the electromagnetic wave; and
a controller configured to control the reflectivity of the time-varying reflective surface and control the electromagnetic wave generator.

3. A device for converting a frequency of an electromagnetic wave, the device comprising:
a semiconductor wafer comprising a time-varying reflective surface onto which an electromagnetic wave is incident and of which reflectivity changes as time elapses; and
a reflective film comprising a partial reflective surface which is disposed to be spaced a predetermined distance from the semiconductor wafer, from which an electromagnetic wave having a frequency corresponding to a resonator mode is emitted, and which has fixed reflectivity for partially reflecting the electromagnetic wave incident through the semiconductor wafer,
wherein the reflectivity of the time-varying reflective surface is less than the reflectivity of the partial reflective surface and increases by an ultrafast laser pulse incident through the reflective film so as to be greater than the reflectivity of the partial reflective surface.

4. The device of claim 3, wherein the time-varying reflective surface is a surface of both surfaces of the semiconductor wafer, which is disposed closer to the reflective film, and
the reflective film comprises a film and a reflective pattern disposed on the film.

5. The device of claim 4, wherein the reflective pattern has a wire grid shape,
a direction of wires of the wire grid shape is parallel to a direction of an electric field of the electromagnetic wave, and
a period of the reflective pattern is less than a wavelength of the electromagnetic wave.

6. The device of claim 4 or 5, wherein the semiconductor wafer is made of silicon or gallium arsenide (GaAs), the film is made of silicon nitride (SiN), polydimethylsiloxane (PDMS), or polyimide (PI), and the reflective pattern is made of a metal or indium tin oxide (ITO).

7. A device for converting a frequency of an electromagnetic wave, the device comprising:
a semiconductor wafer configured to receive an electromagnetic wave and an ultrafast laser pulse to emit a resonance mode electromagnetic wave having a frequency corresponding to a resonator mode,
wherein one surface of both surfaces of the semiconductor wafer is a time-varying reflective surface onto which the electromagnetic wave is incident and of which reflectivity changes as time elapses,
a reflective pattern having fixed reflectivity for partially reflecting the electromagnetic wave is disposed on the other surface of both surfaces of the semiconductor wafer, and
the reflectivity of the time-varying reflective surface is less than the reflectivity of the reflective pattern and increases by an ultrafast laser pulse so as to be greater than the reflectivity of the reflective pattern.

8. The device of claim 7, wherein the semiconductor wafer is made of silicon or gallium arsenide (GaAs), and the reflective pattern is made of a metal or indium tin oxide (ITO).

9. The device of claim 7, wherein the reflective pattern has a wire grid shape,
a direction of wires of the wire grid shape is parallel to a direction of an electric field of the electromagnetic wave, and
a period of the reflective pattern is less than a wavelength of the electromagnetic wave.

10. The device of claim 3 or 7, further comprising:
an electromagnetic wave generator configured to generate the electromagnetic wave;
a laser pulse generator configured to generate the ultrafast laser pulse; and
a controller configured to control the electromagnetic wave generator and laser pulse generator.
